(19) United States
(12) Patent Application Publication
(10) Pub. No.: US 2014/0267250 A1
(43) Pub. Date: Sep. 18, 2014

(54) METHOD AND APPARATUS FOR DIGITAL ELEVATION MODEL SYSTEMATIC ERROR CORRECTION AND FUSION

(71) Applicant: Intermap Technologies, Inc., Englewood, CO (US)

(72) Inventors: J. Keith Tennant, Airdrie (CA); Stephen Charles Griffiths, Calgary (CA); Michael John Wollersheim, Calgary (CA); Nathan Zachary Mercer, Calgary (CA)

(73) Assignee: Intermap Technologies, Inc., Englewood, CO (US)

(21) Appl. No.: 13/841,332

(22) Filed: Mar. 15, 2013

(51) Int. Cl. G06T 17/05

(52) U.S. Cl. CPC G06T 17/05
USPC 345/420

(57) ABSTRACT

A system and method for generating a corrected digital elevation model is configured to remove systematic errors from digital elevation models. A residual dataset that is the difference between a first digital elevation model and a second digital elevation model is obtained and at least one error pattern related to a systematic error is identified. An error model representing at least one error pattern is generated and then removed from the first digital elevation model to create the corrected digital elevation model.

### FIELD OF THE DISCLOSURE

Aspects of the present invention relate to digital environmental mapping and, more particularly, aspects of the present invention involve a system and method for reducing systematic errors in digital elevation maps by recognizing patterns of systematic errors associated with the elevation model acquisition system and removing them.

### BACKGROUND

Digital maps are ubiquitous in today's society. They can be found in applications and web pages being run or accessed by personal computers, cellular phones, automobiles, or other computing devices. Digital maps come in many different varieties and often include elevation models to deliver a more complete view of an area. Elevation models allow for the digital map to include elevation data thus allowing for a three dimensional depiction of terrain, buildings, and other objects. Common examples of a map featuring digital elevation models include Google® Earth, Google® Maps, and Microsoft® Bing Maps.

In order to generate an elevation model, a series of elevation measurements of the area being modeled are taken. This series of elevation measurements form an elevation model dataset that may then be interpreted to produce a digital elevation model (DEM). An elevation model dataset may be created in a number of ways using various technologies. For example, an elevation model dataset could be generated by manually taking altitude measurements across an area. More modern methods of generating elevation model datasets also exist. For example, Photogrammetry, LIDAR, and RADAR are often used to produce elevation model datasets.

Photogrammetry involves the determination of geometric properties using photographic images. The fundamental concept behind photogrammetry is the idea of co-linearity. Co-linearity allows one to establish a relationship between an image and the ground using a bundle of (light) rays defined by the geometry and lens model of the camera (interior and exterior orientation of the camera). Photogrammetry allows for the distance between two points that lie on a plane parallel to the photographic image plane to be determined by measuring their distance on the image assuming that the scale(s) of the images is known. Photographs may be taken using a variety of methods and may include the use of satellites, airplanes, or any other camera with a known location, elevation, and exterior and interior orientation. In stereo photogrammetry, two photographs are taken from disparate positions and compared to generate a dataset for producing a DEM.

Light detection and ranging (LIDAR) based systems operate using an optical sensor and light source. A target is illuminated using the light source, light is reflected back, and a distance calculation is made. If the location and orientation of the LIDAR is known, then the distance may be translated into elevation measurements and assembled into a dataset for constructing a DEM.

RADAR, or more specifically Interferometric Synthetic Aperture Radar (InSAR or IfSAR) is another method of taking elevation measurements for creating a DEM. This method may use two or more synthetic aperture radar (SAR) images to generate an elevation model dataset by using differences in the phase of the waves returning to the sensor.

Each of these methods has varying levels of accuracy and costs associated with them. More accurate systems are naturally more expensive. Each method also is subject to certain levels of systematic error due to inherent attributes of the technology, the quality of system components, the calibration of the system, and the experience of the technician operating them. Furthermore, these systematic errors are usually related to the geometry of the system; being associated with along-collection-track, across-collection-track or upon some boundary condition within the system (frame etc.).

Elevation models can provide either specific point measurements or represent average, minimum, maximum or some other statistical representation of height within an area. Elevation models may also have varying levels of spatial resolution, where the above measurements are made at higher or lower (denser or sparser) spatial resolutions. For example, an elevation model which represents the average height within an area with a resolution of ten meters will have a data point that represents the average elevation of a ten meter by ten meter segment of the terrain.

An ideally calibrated system should yield the same dataset each time when measuring the same area multiple times with the differences being related to noise, temporal errors (for example, plant growth), and changes in height that have occurred between the measurements. Technicians are responsible for creating the DEM using the dataset. A technician is trained to identify errors in the measurements associated with the height measurement approach being used and to minimize them in the DEM. Depending on the level of skill of the technician and the care taken to calibrate the measurement system, the level of systematic errors present in the DEM will be impacted. For example, if two good technicians create elevation models of the same area twice using the same machine and collection methodology, the same data should be produced with the only difference between the datasets being noise. Conversely, if a less experienced technician improperly calibrates equipment and improperly calibrates a dataset, the improper calibrations will be imparted onto the datasets leading to a systematic error being introduced into the DEM.

A common way to improve the quality of a DEM is to use data from multiple datasets. Both errors and noise found in datasets may be reduced by averaging multiple datasets together. One problem with averaging datasets is that if the datasets are exactly aligned, averaging will reduce the sharpness (resolution) of the resulting DEM, but will reduce noise. For example, if five datasets with the same relative noise are averaged, the overall error of the average dataset will be 1/√5 of the original datasets. One problem with this method arises when the datasets have systematic errors. When two datasets are averaged and one or both of the datasets have systematic errors, the average dataset will include both sets of errors at reduced magnitudes depending on the alignment of the systematic errors in each datasets. Thus, if five datasets are averaged, the average dataset will include systematic errors from each of the five datasets each with a reduced magnitude. The result is that the average dataset actually has significantly more errors than any of the original datasets, but each of the errors will be smaller than the originals.

Thus, techniques are described herein to reduce systematic errors in elevation datasets. Among other benefits this allows improvement of all previously corrected data without costly collection of new data. It is with these and other issues in mind that various aspects of the present disclosure were developed.

### SUMMARY

A system and method for generating corrected digital elevation models is configured to remove errors from digital datasets. These datasets may include digital elevation models. Two or more sampled datasets representing the same data may be used to generate residual datasets. A residual dataset is the difference between a first dataset and a second dataset. Error patterns related to systematic errors may be identified in the residual datasets and error models representing the error patterns may be generated. The error models may then be removed from the contributing datasets to create the corrected datasets.

Error patterns may be identified in the spatial domain using morphological techniques or through a manual approach with an experienced user. In order to ease the identification of the patterns, the residual datasets may be transformed into the frequency domain using conventional mathematical methods such as a Fourier transform, discrete cosine transform, Laplace transform, wavelet transform or any other time to frequency domain transform. The patterns may be identified in the frequency domain residual datasets and error models may be made to remove the patterns while in the frequency domain. This may include filtering out frequencies where the error patterns are present.

### BRIEF DESCRIPTION OF THE DRAWINGS

FIG. 1A is a block diagram depicting a system for performing DEM fusion in accordance with various embodiments of the present invention.

FIG. 1B is a block diagram depicting a method for performing DEM systematic error identification and correction in accordance with various embodiments of the present invention.

FIG. 2 is block diagram depicting a method of mapping a high resolution dataset to a low-resolution dataset.

FIG. 3 is an example of a residual dataset in accordance with various embodiments of the present invention.

FIGS. 4A-C depicts various methods for generating a dataset in accordance with various embodiments of the present invention.

FIG. 5A depicts a visual representation of a first DEM in accordance with various embodiments of the present invention.

FIG. 5B depicts a visual representation of a second DEM in accordance with various embodiments of the present invention.

FIG. 6 is a block diagram of an alternative system and method for performing DEM fusion in accordance with various embodiments of the present invention.

FIG. 7A is an example of a plot of a residual dataset with a range error in accordance with various embodiments of the present invention.

FIG. 7B is an example of the residual dataset plotted in the frequency domain.

FIG. 7C depicts the residual dataset, an error model derived from the residual for modifying a source dataset, and a resulting residual dataset after the correction has been applied to the model with the systematic error and the difference taken a second time creating a new residual dataset.

FIG. 7D is an alternative plot comparing the first residual dataset and the second residual dataset.

FIG. 8A is an example of a plot of a residual dataset with a motion error in accordance with various embodiments of the present invention.

FIG. 8B is an example of the residual dataset plotted in the frequency domain.

FIG. 8C depicts the residual dataset, an error model derived from the residual for modifying a source dataset, and a resulting residual dataset after correction has been applied to the model with the systematic error.

FIG. 8D is an alternative plot comparing the first residual dataset and the second residual dataset.

FIG. 9A is an example of a plot of a residual dataset with an error associated with resolution differences between a first and second dataset in accordance with various embodiments of the present invention.

FIG. 9B is an example of the residual dataset plotted in the frequency domain.

FIG. 9C depicts the residual dataset, an error model derived from the residual for modifying a source dataset, and a resulting residual dataset after correction has been applied to the model with the systematic error.

FIG. 9D is an alternative plot comparing the first residual dataset and the second residual dataset.

FIG. 10A is an example of a plot of a residual dataset with off-cardinal range errors and motion errors.

FIG. 10B is an example of the residual dataset plotted in the frequency domain.

FIG. 10C depicts the residual dataset, an error model derived from the residual for modifying a source dataset, and a resulting residual dataset after correction has been applied to the model with the systematic error.

FIG. 10D is an alternative plot comparing the first residual dataset and the second residual dataset.

FIG. 11 is an example of a general purpose computer that may be used in conjunction with the present disclosure.

### DETAILED DESCRIPTION

Implementations of the present disclosure involve a system and method for removing systematic errors from elevation datasets. In particular, the present disclosure provides a system and method for using two or more datasets to identify and remove systematic errors in one or more datasets. This may be done by comparing the datasets to generate residual datasets and identifying patterns in the residual datasets associated with known systematic errors. Once the errors have been identified, the system may remove them from the contributing datasets and more accurate datasets are produced.

FIGS. 1A and 1B illustrate one embodiment of a system and method for dataset fusion. This example utilizes two datasets, but it should be understood that the process may use any number of datasets as inputs and may be repeated multiple times. Each of the datasets may represent a digital elevation model (DEM) corresponding to the same geographic area. These DEM datasets may also have different resolutions and may or may not have been generated using different techniques and systems and include information about how they were produced. For example, the datasets may include information that they were collected using an aircraft with InSAR, the path(s) the aircraft traveled, and the orientation of the InSAR. Generally speaking, the system for dataset fusion 100 may be configured to receive the two DEM datasets 102, 104 (operation 210), compare the datasets to create a residual surface (operation 220), identify systematic errors in the datasets using the residual surface (operation 230), and remove the systematic errors from the higher resolution DEM dataset (operation 240). These operations are described in more detail below.

In this example, the dataset fusion system 100 includes a difference engine 110, a pattern identifier 120, and a sensor error modeler 130. The datasets may include a source DEM dataset 102 and a reference DEM dataset 104. The difference engine 110 may use the source DEM dataset 102 and the reference DEM dataset 104 to produce a residual dataset 112 (operation 220) which may then be outputted to the pattern identifier 120. The pattern identifier 120 may be configured to identify patterns 122, 124 present in the residual dataset 112 that are related to known systematic errors (operation 230). These patterns 122, 124 may then be outputted to the sensor error modeler 130. The sensor error modeler 130 may utilize the patterns 122, 124 identified to define filtering parameters for the source DEM dataset 102. The source DEM dataset 102 may then be filtered and a corrected dataset 140 may be outputted (operation 230).

The source DEM dataset 102 may include any dataset used for producing a DEM that may or may not have systematic errors present. In this example, the source DEM dataset 102 represents a DEM generated by one of the above identified methods of creating an elevation model dataset or any other method for creating an elevation model dataset. For example, the source dataset 102 may comprise a raster representation of a region describing an x-y location and an associated height value with a five meter resolution. Furthermore, the datasets 102, 104 may be stored in one of various data formats that can including a regular spaced grid, a sparse grid (normally associated with a triangular irregular network (TIN)), a random point file (point cloud data), or any other method of storage. These data formats are stored in standard file formats (containers) including, but not limited to, .bil, .tif (normally geoTIFF) and .las. The process is not specific to or dependent on any elevation specific format of data or file format.

The reference DEM dataset 104 may include an additional DEM dataset that describes the same geographical location as the source DEM dataset 102, but was taken by a different means, at a different time, and/or at a different resolution or collection geometry. In this example, the reference DEM dataset 104 may similarly include an elevation model dataset generated by one of the above identified methods of creating an elevation model dataset or any other method of creating an elevation model dataset. In another example, the source DEM dataset 102 and the reference DEM dataset 104 may be created using the same mapping device, but taken a different time using a different configuration. For example, an aircraft taking a first set of measurements may be flying at a first altitude and thus be configured for the first altitude. The same aircraft may then use the same mapping device, but takes the measurements at a different altitude and thus the mapping device has a different configuration. The reference dataset 104 may comprise a dataset describing the same region as the source DEM dataset 102 and likewise is in raster format describing locations and elevations in a region, but has a twenty meter resolution.

In this example, the source DEM dataset 102 has a higher resolution than the reference DEM dataset 104. In some cases, the source DEM dataset 102 and the reference DEM dataset 104 may be of equal resolutions. Generally, the source DEM dataset 102 will be selected to have a greater than or equal resolution than the reference DEM dataset 104. The source DEM dataset 102 and the reference DEM dataset 104 may also include information related to the gathering of the datasets. For example, the source DEM dataset 102 may include that the data was collected using LIDAR and the reference DEM dataset 104 may include that the data was collected using InSAR. The datasets 102, 104 may also include information regarding the details of the data collection. For example, InSAR measurements may be made by an airplane that travels in a relatively straight line for 1000 km taking measurements of a swath of land one kilometer wide for that 1000 km. The dataset created by this InSAR measurement may then include this information. In some cases, the datasets 102, 104 may not need to include specific information about collection techniques because they are known standards.

In various embodiments, the difference engine 110 may be configured to accept the source dataset 102 and the reference dataset 104 as inputs (operation 210). The difference engine 110 may then produce a residual dataset 112 by finding the difference between the source and reference datasets 102,104 (operation 220). The residual dataset 112 may indicate the presence of errors in each of the datasets 102,104. Ideally, there should be no difference between the two datasets 102, 104. In most cases, systematic errors have been introduced into the dataset due to the management of calibration and/or base survey or survey dynamics during the creation of the source dataset 102 and the reference dataset 104. The residual dataset 112 also includes the “noise” associated with the technology used in the survey as well as any errors that correspond to noise inherently generated in the process of creating a DEM.

In many cases the resolution of the source DEM dataset 102 will be higher than the resolution of the reference DEM dataset 104, meaning that the source DEM dataset 102 comprises more data points than the reference dataset 104. Thus, the difference engine 110 cannot directly use the datasets 102, 104 to create the residual dataset 112 since the various data points don't match up. In these cases, each data point in the source DEM dataset 102 may be mapped to a lower resolution equivalent before generating the residual dataset 112. For example, referring to FIG. 2, the higher resolution data points 320 may be mapped to corresponding lower resolution data point 310. In this case, each set of data points 320 may be mapped to a corresponding lower resolution data point 310 each with the average height information of the higher resolution data points 320 and occupying the same space as the original high resolution data points 320. Thus, there is no new information added during the mapping process and the DEM produced from the resampled low resolution dataset will merely result in roughly the same DEM at a lower resolution. Once the equivalent lower resolution reference DEM dataset has been created, the difference engine may find the residual dataset 112.

Referring to FIG. 3, an example of residual dataset 112 is depicted. In this example, the coloring indicates differences between datasets 102, 104 as represented by the legend. Several systematic errors 410, 420, 430 may also be seen. In this case, the depicted errors show characteristics associated with known systematic errors for radar sensors such as InSAR sensors. Sensors used by other systems also show characteristics associated with known systematic errors, but the characteristics and errors vary based on the type of sensors and methodologies used. Another example of this is warp and bias errors caused by photography or radar based stereo calibration errors that span the footprint of one or more stereo digital elevation model areas or scenes. This residual dataset shows a range error 410, an off-cardinal range error 420, and motion ripples 430. Range errors 410, 420 are associated with errors over a specific path. For example, an improperly calibrated instrument taking measurements from an airplane will introduce errors over the entire path of the airplane resulting in a long visible area in the residual dataset 112. Range errors may also be off-cardinal as shown by the off-cardinal range error 420. This off-cardinal range error 420 was introduced when multiple flight paths were used, one of which was off-cardinal. Motion ripples 430 are associated with the unmodeled or uncompensated sensor motion caused. For example, airplanes rarely are able to maintain an exactly constant altitude. Instead, the airplane will generally move up and down according to variations in weather, turbulence, and the terrain being flown over.

Returning to FIGS. 1A-B and with continued reference to FIG. 3, the pattern identifier 120 may process the residual dataset 112 and identify patterns and trends. The processing may be done geospatially and identify temporal patterns and/or systematic trends in the residual dataset 112. For example, patterns indicating the range errors 410, 420 and the motion ripples 430 can be identified. There are numerous techniques for recognizing patterns in the datasets and any of these methods may be used. For example, patterns may be identified manually by an experienced user or automatically using morphological techniques such as using edge detection in the residual dataset 112 and comparing to patterns in the pattern database 126. The comparison may be done by using one of many pattern matching algorithms, including, but not limited to clustering algorithms, classification algorithms, or regression algorithms. One or more patterns 122, 124 in the residual dataset 112 may be identified (operation 230) and these patterns may be outputted to the sensor error modeler 130.

The pattern database 126 may include a database of patterns associated with systematic errors. For example, each type of sensor used for gathering data for a DEM may be associated with certain error patterns in a residual dataset. LIDAR systems are associated with certain known error patterns, RADAR systems are associated with different known error patterns, and photography-based systems are associated with different known error patterns. Patterns may also be associated with a platform that the measurements are taken from, such as a satellite or airplane. For example, patterns may be known for range errors, motion errors, off-cardinal range errors, and combinations of these errors for radar systems. Additionally, patterns may be known for warps or biases caused by stereo model calibration errors over the footprint of one or more photography-based stereo scenes. Each of these known residual error patterns may be included in the pattern database 126, and may be associated with the appropriate input DEM dataset when the error models are extracted from the residual dataset(s).

Information regarding the method of collecting the data in the source DEM dataset 102 and the reference DEM dataset 104 may also be used to help identify patterns in the residual dataset 112. Referring now to FIGS. 4A-C various methodologies for collecting data for the region 500 are depicted. For example, in FIG. 4A, an aircraft equipped with a RADAR based measurement system may travel along routes 502, 504, 506 taking measurements in a preset direction 502, 504, 506. As the aircraft travels along route 502, the area 514 is scanned and measurements are recorded. Similarly, when the aircraft travels along routes 504 and 506, areas 516 and 518 are scanned and measurements are recorded. If there is a systematic error present when any of the routes 502, 504, or 506 are scanned then the systematic error will show up along the route in the residual dataset 112.

In other cases, the system may be configured to take measurements of the region 500 at various angles relative to the aircraft as shown by FIG. 4B and the preset directions 514, 516, 518. FIG. 4C depicts measurements made covering an area from a stationary point. The datasets 102, 104 may include information about the collection of the data and the pattern identifier 120 may then use this information to help identify patterns. Furthermore, it should be understood that the dataset generation may be done in any manner and that depending on the path that the instrument is moving while taking measurements, certain errors will be introduced and any analysis may be adjusted accordingly.

The identified patterns 122, 124 may be fed into the sensor error modeler 130 for constructing a filter 132 to remove the errors associated with the pattern. Once the error patterns have been identified as being caused by systematic errors, they can be removed without worrying about harming the reference DEM dataset 102. This is done by constructing the filter 132 using the patterns 122, 124 and the residual values contained in residual dataset 112. In a simplified example, the pattern 122 was found to be in the residual dataset 112. This pattern 122 extends across two data points in the residual dataset and each residual data point is equal to one meter. A filter 132 may then be constructed to remove one meter from the source DEM dataset 102 at the corresponding two data points. In other words, the filter will include information for modifying the source DEM dataset 102 to remove the identified systematic errors. Once the filter is constructed, the systematic errors may be removed from the source DEM dataset 102 and the resulting corrected DEM dataset 140 may be outputted (operation 240).

Referring now to FIGS. 5A-B, an example of two DEMs 600, 700 created from a source DEM dataset 102 and reference DEM dataset 104 are depicted. In FIG. 5A, the DEM 600 was created by the source dataset 102. This DEM exhibits horizontal banding 610 caused by systematic errors such as aircraft motion during data collection. In FIG. 5B, the horizontal banding is not depicted, but the DEM 700 is clearly not as detailed as the DEM 600. These two DEMs and their corresponding datasets may be used as input for the system 100 according to the method 200 to remove the banding 610 caused by systematic errors.

Referring now to FIG. 6, a more detailed embodiment of a system and method for DEM fusion 800 is depicted. In this embodiment, the system and method for DEM fusion performs pattern recognition in the frequency domain instead of the spatial domain. Similarly to the embodiment described above, in this embodiment, a source DEM dataset 802 and a reference DEM dataset 804 may be used as inputs. The various terrain features described by the datasets 802, 804 can be described in terms of high and low frequency data. High frequency data contains spatial features, terrain break, and drain lines. Low frequency data contains bias, range errors, and motion ripples. Again, similar to the above described embodiment, a residual dataset may be generated (operation 806). The residual dataset 806 is then used for pattern matching and an error model surface may be generated (operation 808). The residual dataset may then be transformed to the frequency domain (operation 812). The now frequency domain error model may then be used in conjunction with user input parameters 810 so that frequency filtering parameters may be automatically generated (operation 814) This may be done using fast Fourier transforms (FFT) to the residual dataset or by using any other method of transforming the residual dataset to the frequency domain. In other embodiments, a different type of spatial to time domain transform may be used. For example, the system may utilize discrete cosine transforms, Laplace transforms, or wavelet transforms. Once the residual dataset is in the frequency domain it may be compared to known patterns associated to systematic errors and a new error model may be generated (operation 816). In the case of multiple error models (for multiple systematic errors found in the residual dataset), the error models may then be combined according to the user input parameters 810 (operation 818) to form the combined error model 820. The combined error model 820 may be transformed back into the spatial domain and applied to the source DEM dataset 802 (operation 822). The corrected dataset may then be outputted (operation 824).

For the particular radar case in this embodiment, two types of low frequency errors may be removed using this process, including range errors and motion ripples, whether they be present in various collection geometries. Each type of error is exhibited at a different frequency or range of frequencies. One or more filters may be created to remove these frequencies from the dataset and thus remove the errors from the dataset.

With continued reference to FIG. 6, referring now to FIG. 7A, the datasets may be used to produce the residual dataset 900 (operation 806). This residual dataset features banding 902, 904 consistent with range errors. This surface may be evaluated to create an error model (operation 808) to be used in conjunction with user input parameters 810. Referring now to FIG. 7B, the residual dataset 900 is transformed into the frequency domain to produce the residual dataset 910 (operation 812) and filtering parameters may be determined (operation 814). In this example, the residual dataset 910 exhibits a sharp, centrally located vertical line 920. This line may be associated with the range error. Parameters for a notch filter, otherwise known as a band-reject or band-stop filter may be determined to remove the frequency of the vertical line from the residual dataset (operation 816). This filter may then be transformed back from frequency space to create an error model (operation 820). Referring now to FIG. 7C, the error model 930 is depicted along with the residual dataset 900 and a corrected residual dataset 940. The error model 930 may be applied to the source dataset to create a corrected dataset (operation 822). If the corrected dataset is compared to the reference dataset, the new residual dataset 940 no longer exhibits the banding of the original residual dataset. Referring now to FIG. 7D, two line graphs depict the original residual dataset (line 940) and the corrected residual dataset (line 950). The banding shown by the peaks of the original residual dataset 900 has been removed from the corrected residual dataset 940. This comparison is done merely to show the improvement of the corrected dataset as compared to the source DEM dataset 802.

With continued reference to FIG. 6, referring now to FIG. 8A, the datasets may be used to produce the residual dataset 1000 (operation 806). This residual dataset features ripples 1002 consistent with motion errors. This surface may be evaluated to create an error model (operation 808) to be used in conjunction with user input parameters 810. Referring now to FIG. 8B, the residual dataset 1000 is transformed into the frequency domain to produce the residual dataset 1010 (operation 812) and filtering parameters may be determined (operation 814). In this example, the residual dataset 1010 similar to the residual dataset 910, exhibits a sharp, centrally located vertical line associated with the range error. The residual dataset 1010 also exhibits a sharp centrally located horizontal line 1020 associated with the motion ripples 1002. A diagonal line 1030 may also be observed. This diagonal line may be associated with off-cardinal motion ripples, caused by merging two radar DEM datasets collected by the same system flown at different headings. A notch filter may be generated for removing these errors from the residual dataset (operation 816). This filter may then be transformed back from frequency space to create an error model (operation 820). Referring now to FIG. 8C, the error model 1040 is depicted along with the residual dataset 1000 and a corrected residual dataset 1050. The error model 1040 may be applied to the source dataset to create a corrected dataset (operation 822). If the corrected dataset is compared to the reference dataset, the new residual dataset 1050 no longer exhibits the ripples of the original residual dataset. Referring now to FIG. 8D, two line graphs depict the original residual dataset (line 1060) and the corrected residual dataset (line 1070). The ripples shown by the peaks of the original residual dataset 1000 has been removed from the corrected residual dataset 1050. Again, this comparison is done merely to show the improvement of the corrected dataset as compared to the source DEM dataset 802.

With continued reference to FIG. 6, referring now to FIG. 9A, the datasets may be used to produce the residual dataset 1100 (operation 806). This residual dataset features errors related to high terrain relief. These errors also obstruct any observation of range and motion error. This surface may be evaluated to create an error model (operation 808) to be used in conjunction with user input parameters 810. Referring now to FIG. 9B, the residual dataset 1100 is transformed into the frequency domain to produce the residual dataset 1110 (operation 812) and filtering parameters may be determined (operation 814). In this example, the residual dataset 1110 exhibits a plurality of off-center horizontal lines 1120 and off-center vertical lines 1130 that are only present on the outer edges of the residual dataset 1110 and not through the center of the plot. These lines are associated with range errors and with high terrain relief errors. High terrain relief errors stem from the resolution differences between the source DEM dataset 802 and the reference DEM dataset 804. A notch filter may be generated for removing the range errors from the residual dataset while leaving the terrain relief errors (operation 816). This filter may then be transformed back from frequency space to create an error model (operation 820). Referring now to FIG. 9C, the error model 1140 is depicted along with the residual dataset 1100 and a corrected residual dataset 1150. The error model 1140 may be applied to the source dataset to create a corrected dataset (operation 822). If the corrected dataset is compared to the reference dataset, the new residual dataset 1150 no longer exhibits the range errors of the original dataset, but has maintained the high terrain relief errors of the original residual dataset. Referring now to FIG. 9D, two line graphs depict the original residual dataset (line 1160) and the corrected residual dataset (line 1170). The corrected residual dataset (line 1170) still tracks the original residual dataset (line 1160), but with a reduced amount of error. Again, this comparison is done merely to show the improvement of the corrected dataset as compared to the source DEM dataset 802.

With continued reference to FIG. 6, referring now to FIG. 10A, the datasets may be used to produce the residual dataset 1200 (operation 806). This residual dataset features errors related to high terrain relief as well as range and motion errors. This surface may be evaluated to create an error model (operation 808) to be used in conjunction with user input parameters 810. Referring now to FIG. 10B, the residual dataset 1200 is transformed into the frequency domain to produce the residual dataset 1210 (operation 812) and filtering parameters may be determined (operation 814). In this example, the residual dataset 1210 exhibits a plurality of off-center horizontal lines 1220 and off-center vertical lines 1230 that are only present on the outer edges of the residual dataset 1210 as well as a diagonal line 1240 through the middle of the plot. The off-center horizontal and vertical lines 1220, 1230 are associated with the high terrain relief, or in other words, the resolution differences between the source DEM dataset 802 and the reference DEM dataset 804. The diagonal line 1240 is caused by off-cardinal range errors. A notch filter may be generated for removing the off-cardinal range errors from the residual dataset, while leaving the terrain errors (operation 816). This filter may then be transformed back from frequency space to create an error model (operation 820). Referring now to FIG. 100, the error model 1250 is depicted along with the residual dataset 1200 and a corrected residual dataset 1260. The error model 1250 may be applied to the source dataset to create a corrected dataset (operation 822). If the corrected dataset is compared to the reference dataset, the new residual dataset 1260 still exhibits the high terrain relief errors, but no longer exhibits the range errors of the original residual dataset 1200. Referring now to FIG. 10D, two line graphs depict the original residual dataset (line 1270) and the corrected residual dataset (line 1280). The corrected residual dataset (line 1280) still tracks the original residual dataset (line 1270), but with a reduced amount of error and no longer has the peak associated with the range error. Again, this comparison is done merely to show the improvement of the corrected dataset as compared to the source DEM dataset 802.

In various other embodiments, once the corrected dataset has been produced, it may be used to reduce the noise in the reference DEM dataset. Once the systematic errors have been removed from a DEM dataset, the errors in the corrected dataset should only include noise. This noise may be reduced by simply averaging the corrected dataset with another DEM dataset of the same area assuming the DEMs are properly aligned.

FIG. 11 illustrates an example general purpose computer 1100 that may be useful in implementing the described technology. The example hardware and operating environment of FIG. 11 for implementing the described technology includes a computing device, such as general purpose computing device in the form of a personal computer, server, or other type of computing device. In the implementation of FIG. 11, for example, the general purpose computer 1100 includes a processor 1110, a cache 1160, a system memory 1170, 1180, and a system bus 1190 that operatively couples various system components including the cache 1160 and the system memory 1170, 1180 to the processor 1110. There may be only one or there may be more than one processor 1110, such that the processor of general purpose computer 1100 comprises a single central processing unit (CPU), or a plurality of processing units, commonly referred to as a parallel processing environment. The general purpose computer 1100 may be a conventional computer, a distributed computer, or any other type of computer; the invention is not so limited.

The system bus 1190 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 1170 and random access memory (RAM) 1180. A basic input/output system (BIOS) 1172, containing the basic routines that help to transfer information between elements within the general purpose computer 1100 such as during start-up, is stored in ROM 1170. The general purpose computer 1100 further includes a hard disk drive 1120 for reading from and writing to a persistent memory such as a hard disk, not shown and an optical disk drive 1130 for reading from or writing to a removable optical disk such as a CD ROM, DVD, or other optical media.

The hard disk drive 1120 and optical disk drive 1130 are connected to the system bus 1190. The drives and their associated computer-readable media provide nonvolatile storage of computer-readable instructions, data structures, program engines and other data for the general purpose computer 1100. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk 1120, optical disk 1130, ROM 1170, or RAM 1180, including an operating system 1182, a digital elevation model and systematic error correction and fusion program 1184, one or more application programs 1186, and program data 1188. A user may enter commands and information into the general purpose computer 1100 through input devices such as a keyboard and pointing device connected to the USB or Serial Port 1140. These and other input devices are often connected to the processor 110 through the USB or serial port interface 1140 that is coupled to the system bus 1190, but may be connected by other interfaces, such as a parallel port. A monitor or other type of display device may also be connected to the system bus 1190 via an interface, such as a video adapter 1160. In addition to the monitor, computers typically include other peripheral output devices (not shown), such as speakers and printers.

The general purpose computer 1100 may operate in a networked environment using logical connections to one or more remote computers. These logical connections are achieved by a network interface 1150 coupled to or a part of the general purpose computer 1100; the invention is not limited to a particular type of communications device. The remote computer may be another computer, a server, a router, a network PC, a client, a peer device, or other common network node, and typically includes many or all of the elements described above relative to the general purpose computer 1100. The logical connections include a local-area network (LAN) a wide-area network (WAN), or any other network. Such networking environments are commonplace in office networks, enterprise-wide computer networks, intranets and the Internet, which are all types of networks.

The network adapter 1150, which may be internal or external, is connected to the system bus 1150. In a networked environment, programs depicted relative to general purpose computer 1100, or portions thereof, may be stored in the remote memory storage device. It is appreciated that the network connections shown are example and other means of and communications devices for establishing a communications link between the computers may be used.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A method for generating a corrected digital elevation model comprising:
obtaining a residual dataset by determining a difference between a first digital elevation model and a second digital elevation model;
identifying at least one error pattern in the residual dataset related to a systematic error in the first digital elevation model;
generating an error model representing at least one error pattern; and
removing the error model from the first digital elevation model to generate a corrected digital elevation model.

2. The method of claim 1, wherein:
the first digital elevation model was generated using a first mapping device; and
the second digital elevation model was generated using a second mapping device.

3. The method of claim 1, wherein:
the first digital elevation model was generated using a first mapping device operating in according to a first configuration; and
the second digital elevation model was generated using the first mapping device operating according to a second configuration, wherein the second configuration differs from the first configuration.

4. The method of claim 1, wherein the first digital elevation model and the second digital elevation model represent a single geographic area.

5. The method of claim 1, further comprising transforming the residual dataset from a spatial domain to a frequency domain, and wherein the at least one error pattern in the residual dataset is identified in the frequency domain.

6. The method of claim 5, wherein the error model is generated by:
defining a notch filter for removing an identified error pattern;
producing a notch filter based error model according to the notch filter.

7. The method of claim 1, wherein identifying at least one error pattern in the residual dataset related to a systematic error in the first digital elevation model comprises evaluating the residual dataset according to at least one morphological technique.

8. The method of claim 1, wherein the systematic error identified, comprises at least one of a range error and a motion ripple error.

9. The method of claim 1, wherein the systematic error comprises at least one of a warp and bias associated with a photography-based or radar-based stereo model calibration error.

10. The method of claim 1, further comprising:
obtaining a second residual dataset wherein comprising a difference between the first digital elevation model and a third digital elevation model;
identifying at least one error pattern in the second residual dataset related to a systematic error in at least the first digital elevation model; and
generating a second error model representing at least one error pattern; and
removing the second error model from the first digital elevation model to generate a second corrected digital elevation model.

11. The method of claim 11, further comprising averaging the corrected digital elevation model with the second corrected digital elevation model.

12. A method for generating a corrected digital elevation model comprising:
obtaining a residual dataset by determining a difference between a first digital elevation model and a second digital elevation model, wherein the first digital elevation model and the second digital elevation model comprise a single geographic area;
transforming the residual dataset into a frequency domain dataset;
identifying at least one error pattern in the frequency domain dataset related to a systematic error in the first digital elevation model;
generating an error model representing at least one error pattern; and
removing the error model from the first digital elevation model to generate a corrected digital elevation model.

13. The method of claim 12, wherein:
the first digital elevation model was generated using a first mapping device; and
the second digital elevation model was generated using a second mapping device.

14. The method of claim 12, wherein:
the first digital elevation model was generated using a first mapping device operating in according to a first configuration; and
the second digital elevation model was generated using the first mapping device operating according to a second configuration, wherein the second configuration differs from the first configuration.

15. The method of claim 12, wherein transforming the residual dataset into a frequency domain dataset comprises transforming the residual dataset using a Fourier transform.

16. The method of claim 12, wherein transforming the residual dataset into a frequency domain dataset comprises transforming the residual dataset using a discrete cosine transform.

17. The method of claim 12, wherein transforming the residual dataset into a frequency domain dataset comprises transforming the residual dataset using a Laplace transform.

18. The method of claim 12, wherein transforming the residual dataset into a frequency domain dataset comprises transforming the residual dataset using a wavelet transform.

19. The method of claim 15, wherein the error model is generated by:
defining a notch filter for removing an identified error pattern;
producing a notch filter based error model according to the notch filter.

20. The method of claim 13, wherein the systematic error identified comprises at least one of a range error and a motion ripple error.

21. The method of claim 13, wherein the systematic error comprises at least one of a warp and bias associated with a photography-based or radar-based stereo model calibration error.

22. The method of claim 13, further comprising:
obtaining a second residual dataset wherein the second residual dataset comprises a difference between a first digital elevation model and a third digital elevation model;
identifying at least one error pattern in the second residual dataset related to a systematic error in at least the first digital elevation model; and
generating a second error model representing at least one error pattern; and
removing the second error model from the first digital elevation model to generate a second corrected digital elevation model.

23. The method of claim 22, further comprising averaging the corrected digital elevation model with the second corrected digital elevation model.

24. A system for generating a corrected digital elevation model comprising:
a processor coupled with a memory, wherein the processor is configured to execute instructions stored in the memory to generate the corrected digital elevation model comprising:
obtaining a residual dataset by determining a difference between a first digital elevation model and a second digital elevation model;
identifying at least one error pattern in the residual dataset related to a systematic error in the first digital elevation model;
generating an error model representing at least one error pattern; and
removing the error model from the first digital elevation model to generate a corrected digital elevation model.

25. The system of claim 24, wherein:
the first digital elevation model was generated using a first mapping device; and
the second digital elevation model was generated using a second mapping device.

26. The system of claim 24, wherein:
the first digital elevation model was generated using a first mapping device operating in according to a first configuration; and
the second digital elevation model was generated using the first mapping device operating according to a second configuration.

27. The system of claim 24, further comprising transforming the residual dataset from a spatial domain to a frequency domain.

28. The system of claim 27, wherein the error model is generated by:
defining a notch filter for removing the identified error pattern;
producing a notch filter based error model according to the notch filter.

29. The system of claim 24, wherein identifying at least one error pattern in the residual dataset related to a systematic error in the first digital elevation model comprises evaluating the residual dataset according to at least one morphological technique.

30. The system of claim 24, wherein the systematic error identified comprises at least one of a range error and a motion ripple error.

31. The system of claim 24, wherein the systematic error comprises at least one of a warp and bias associated with a photography-based or radar-based stereo model calibration error.

32. The system of claim 24, further comprising:
obtaining a second residual dataset wherein the second residual dataset comprises a difference between a first digital elevation model and a third digital elevation model;
identifying at least one error pattern in the second residual dataset related to a systematic error in at least the first digital elevation model; and
generating a second error model representing at least one error pattern; and
removing the second error model from the first digital elevation model to generate a second corrected digital elevation model.

33. The method of claim 32, further comprising averaging the corrected digital elevation model with the second corrected digital elevation model.
